(19) United States
(12) Patent Application Publication
(10) Pub. No.: US 2025/0348504 A1
(43) Pub. Date: Nov. 13, 2025

(54) Search System for Providing Categorical Search Results Via Generative Models

(71) Applicant: Google LLC, Mountain View, CA (US)

(72) Inventors: Martin Thomas Moore, Ann Arbor, MI (US); George Alban Heitz, III, New York, NY (US); Evan Hodges-LeClaire, Brooklyn, NY (US); Allison Brenna Mercurio, Longmont, CO (US); Andre Lentz, Brooklyn, NY (US); Ahmed Kachkach, Horgen (CH); Alexis Catherine Saiontz, Brooklyn, NY (US); Shu Tao, Chappaqua, NY (US); Emily Louise Rothschild, New York, NY (US)

(21) Appl. No.: 19/202,970

(22) Filed: May 8, 2025

Related U.S. Application Data
(60) Provisional application No. 63/646,220, filed on May 13, 2024.

(51) Int. Cl. G06F 16/248

(52) U.S. Cl. CPC G06F 16/248

(57) ABSTRACT

Provided are systems and methods that use generative models such as large language models (LLMs) to assist in generating topic-organized search result pages. In particular, an example system can use a generative model to generate a number of different topics in response to a user query. A number of search results can be retrieved for each different topic. The search system can integrate all of the search results into a coherent search results page that is structured by topic. The resulting generating topic-organized search result page can provide a more intuitive and easily-navigable search experience.

### PRIORITY CLAIM

The present application claims priority to U.S. Provisional Application No. 63/646,220 filed May 13, 2024 which is hereby incorporated by reference herein in its entirety.

### FIELD

The present disclosure relates generally to information retrieval via search engine technology. More particularly, the present disclosure relates to a search system that leverages one or more generative models to provide categorical search results.

### BACKGROUND

Modern search engine systems are designed to handle and process vast amounts of data to provide users with relevant search results. However, traditional search engines often encounter substantial technical challenges that can diminish their efficiency and effectiveness. In particular, one technical challenge arises when users make general queries, to which traditional search engines respond with a long list of results that are typically organized by a basic measure of relevance. This often leads to the presentation of redundant information across multiple results.

Providing results that contain redundant information leads to unnecessary resource consumption. Specifically, when users explore multiple redundant results (e.g., by opening individual links), it results in significant computational expenditure by various components of the broader computer-based network, such as the user's device and/or other network components. In particular, each access and download of redundant content from different sources requires substantial data processing and bandwidth.

### SUMMARY

Aspects and advantages of embodiments of the present disclosure will beset forth in part in the following description, or can be learned from the description, or can be learned through practice of the embodiments.

One example aspect of the present disclosure is directed to computer-implemented method to provide topic-organized search results. The method includes obtaining, by a computing system comprising one or more computing devices, an input query. The method includes processing, by the computing system, the input query with a generative model to generate a plurality of topics. The method includes determining, by the computing system, one or more search results for each of the plurality of topics. The method includes generating, by the computing system, instructions for presenting a topic-organized search results page that is structured according to the plurality of topics and provides the one or more search results for each of the plurality of topics. The method includes providing, by the computing system, the instructions for presenting the topic-organized search results page to cause display of the topic-organized search results page on a display device.

Example implementations can include any combination of the following features. In some implementations, processing, by the computing system, the input query with the generative model to generate the plurality of topics comprises: supplementing, by the computing system, the input query with one or more sets of context data to generate a context-supplemented input query; and processing, by the computing system, the context-supplemented input query with the generative model to generate the plurality of topics. In some implementations, the one or more sets of context data comprise user preferences or user browsing history associated with a user that submitted the input query. In some implementations, processing, by the computing system, the input query with the generative model to generate the plurality of topics comprises processing, by the computing system, the input query with the generative model to generate a plurality of topic tuples as an output of the generative model, wherein each of the plurality of topic tuples comprises one or more topic-specific queries and identifies one or more particular search index types or data sources to query using the one or more one or more topic-specific queries. In some implementations, determining, by the computing system, the one or more search results for each of the plurality of topics comprises, for each topic tuple, querying, by the computing system, the one or more particular search index types or data sources identified by the topic tuple with the one or more topic-specific queries to retrieve the one or more search results for the topic associated with the topic tuple. In some implementations, generating, by the computing system, the instructions for presenting the topic-organized search results page comprises, for at least one of the one or more search results, applying, by the computing system, a template to metadata associated with the search result to generate a result representation for inclusion in the topic-organized search results page. In some implementations, generating, by the computing system, the instructions for presenting the topic-organized search results page comprises, for at least one of the topics, processing, by the computing system, data associated with the topic with a second generative model to generate a textual justification or preamble for the topic, wherein the textual justification or preamble is included in the topic-organized search results page. In some implementations, the topic-organized search results page presents the plurality of topics ordered from general to specific. In some implementations, the topic-organized search results page presents the plurality of topics respectively in a plurality of visual cards, wherein the plurality of visual cards are arranged vertically, and wherein the one or more search results for each topic are arranged horizontally within the visual card associated with that topic. In some implementations, the method includes processing, by the computing system, the input query with an intent classification model to generate one or more intent labels that describes an intent of the input query. In some implementations, processing, by the computing system, the input query with the generative model to generate the plurality of topics comprise processing, by the computing system, the input query and the one or more intent labels with the generative model to generate the plurality of topics. In some implementations, the generative model comprises a sequence processing model, the sequence processing model comprising a language model or a multi-modal model.

Other aspects of the present disclosure are directed to various systems, apparatuses, non-transitory computer-readable media, user interfaces, and electronic devices, including systems, apparatuses, non-transitory computer-readable media, user interfaces, and electronic devices for performing the method described above.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example search system operating to generate a topic-organized search results page according to example embodiments of the present disclosure.

FIG. 2 depicts a more detailed block diagram of an example search system according to example embodiments of the present disclosure.

FIG. 3 depicts a flow chart diagram of an example method to generate a topic-organized search results page according to example embodiments of the present disclosure.

FIG. 4 depicts a series of example user interfaces displaying a topic-organized search results page according to example embodiments of the present disclosure.

FIG. 5A depicts a block diagram of an example computing system that performs information retrieval according to example embodiments of the present disclosure.

FIG. 5B depicts a block diagram of an example computing system that performs information retrieval according to example embodiments of the present disclosure.

Reference numerals that are repeated across plural figures are intended to identify the same features in various implementations.

### DETAILED DESCRIPTION

Example aspects of the present disclosure are directed to systems and methods that use generative models such as large language models (LLMs) to assist in generating topic-organized search result pages. In particular, an example system can use a generative model to generate a number of different topics in response to a user query. A number of search results can be retrieved for each different topic. The search system can integrate all of the search results into a coherent search results page that is structured by topic. The resulting generating topic-organized search result page can provide a more intuitive and easily-navigable search experience.

More particularly, a search system can receive a user query through an interface. In some implementations, the user input can be received through an interface which can include direct text input, voice commands, or image-based queries.

To enhance the relevance and personalization of the search results, the system can optionally combine the user query with additional contextual information. This context may include user preferences, the time of day, or other metadata. In some implementations, these data sources can be accessed via APIs and preprocessed to normalize data inputs.

In some implementations, the system can also classify the type of query to determine the user's intent, which may range from making a decision to exploring options. This classification can be achieved using natural language processing algorithms and intent recognition models, which help in categorizing the query and directing subsequent processing flows.

A generative model (e.g., LLM) can process the query and any other contextual data to generate a plurality of topic tuples that correspond to a plurality of topics. Each topic tuple created by the generative model can include several components: identification of one or more specific backend search indices; a topic title that succinctly describes the topic; and one or more specific model-generated queries that are designed to retrieve results from the identified backend search index for the particular topic. Thus, this step leverages the sequence processing capabilities of generative models to extrapolate potential topics that are tailored to the user's query and context.

The search system can use the model-generated queries contained in the topic tuples to retrieve results from the specified backend indices. In particular, the topic tuples are structured to guide the retrieval of results from various backend search indices, which can include web, forums, videos, places, recipes, products/shopping, images, news, bookable experiences, and/or other sources of content. For each topic tuple, specific queries can be sent to the respective backend search index, and the system can perform database queries or API calls to external content providers to fetch the relevant content.

Next, the search system can integrate the retrieved results for all of the topic tuples into a structured search results page. For example, the integration can be facilitated using predefined templates that organize the content into a coherent and user-friendly format. As an example, the templates can be designed using HTML/CSS or other formats and enhanced with JavaScript or other code types for dynamic content handling.

In some implementations, the search system can build the search results page from a mix of actual results retrieved from the backend search indices and also some amount of model-generated content, such as textual justifications or preambles for each topic. In particular, to further enhance the user experience, the system can generate model-driven textual justifications or preambles for each topic. These textual elements can provide additional context or explanations about the results, helping to enhance user understanding and engagement with the content. The generation of these texts can be performed by LLMs or other related models that are configured to create explanatory or supplementary text.

In this manner, the search system can generate a search results page that is organized by topic. A s a result, the search results page is not only informative but also coherent and easy to navigate, significantly improving the user's search experience by making it more intuitive and aligned with their expectations.

The layout of the search results page is strategically designed to enhance user engagement and satisfaction. Initially, the page presents the most general topics at the top, directly answering the user's initial query. As the user scrolls down, the topics progressively become more specific and intriguing, culminating in unexpected yet relevant topics at the bottom of the page. This structured progression is designed to inspire and engage users, encouraging them to explore further and discover content that they might not have initially considered.

Regarding user interaction and intent refinement, the search system incorporates interactive features that enable users to refine their search intents after viewing the initial results. These features provide users with lightweight, engaging methods to specify more detailed preferences or to explore related topics. Such interactivity not only enhances the user experience but also helps the system to better understand and adapt to user needs.

The system is further equipped to dynamically adjust the topics and content presented based on user interactions. The generative model that powers search can modify the displayed topics and content in real-time, ensuring that the search results continuously align with the user's evolving interests and preferences. This dynamic adjustment capability allows the system to maintain the relevance and appeal of the search results.

In some implementations, the system can dynamically adjust the content presentation based on real-time user interactions with the results page. This dynamic adjustment can include real-time processing of user feedback and A/B testing of different layout variations to optimize user engagement and satisfaction.

The system also includes mechanisms for tracking user interactions with the presented topics and results. This tracking can be achieved through web analytics tools that monitor events and measure user engagement metrics, providing valuable insights into user behavior and preferences.

Finally, the system can utilize user feedback to continuously refine the LLM's processing of queries. This feedback loop allows the system to learn from real-world usage data and make iterative improvements to the model, ensuring that the search results remain relevant and beneficial to users over time.

Thus, example implementations of the present disclosure leverage the capabilities of generative models, particularly sequence processing models such as LLMs, to enhance the search process. By utilizing LLMs, the proposed systems can understand and match user intents through the dynamic generation of context-aware topics. These topics can be selected to be directly relevant to the user's expressed and inferred needs, thereby increasing the relevance and personalization of the search results.

The systems and methods of the present disclosure provide a number of technical effects and benefits. As one example, the proposed systems organize search outcomes into clearly defined categories based on the relevance and context of the user's query. This topic-structured approach significantly streamlines the search process by reducing redundancy and focusing on delivering distinct, non-overlapping content within each categorized topic. By presenting results in an organized manner, the system minimizes the need for users to manually sift through extensive lists of potentially redundant results, thereby reducing the computational load associated with processing multiple user requests for similar content. In particular, by providing a diverse set of results which are clearly organized by topic, the proposed approach can reduce the number of instances in which a user retrieves redundant web resources. Reducing the retrieval of redundant web resources saves computational resources such as processor cycles, memory space, and network bandwidth.

With reference now to the Figures, example embodiments of the present disclosure will be discussed in further detail.

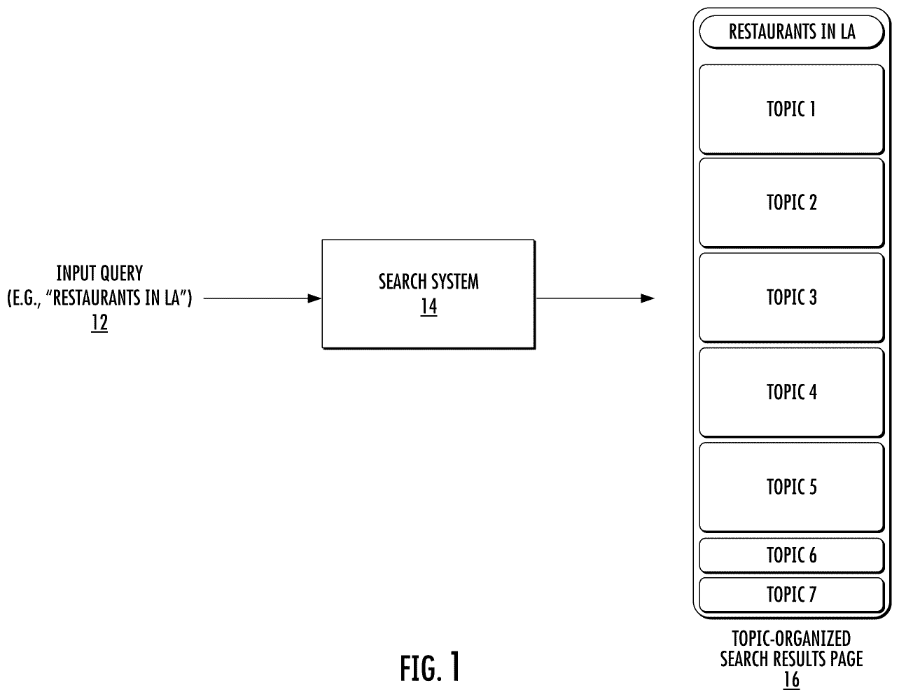

Referring now to FIG. 1, a block diagram illustrating an example embodiment of the search system 14 for generating a topic-organized search results page 16 is depicted. The diagram shows the flow of data from an input query 12 to the final display of the search results page 16, organized by topics. This figure illustrates the operation and data flow within the search system, which leverages generative models to enhance the search experience by providing categorical search results.

The process begins with an input query 12, such as “Restaurants in LA”. This query represents a user's search intent, entered into the system through a user interface, which can include forms of input such as text, voice, and/or image-based queries. In some implementations, the input query 12 can be supplemented with additional context data, such as user preferences, current location, time of day, or browsing history, to form a context-supplemented input query. This additional context helps in refining the search results to better match the user's intent and personal preferences.

Upon receiving the input query 12, the search system 14 processes this query using a generative model, for example an LLM. The LLM analyzes the query and the associated context to dynamically generate a plurality of topic tuples. Each topic tuple includes a topic title and one or more specific queries tailored to retrieve relevant information from various backend search indices. These indices could include databases containing information about web pages, forums, videos, places, recipes, products, images, news, and bookable experiences.

Following the generation of topic tuples, the search system 14 retrieves results for each topic from the respective backend search indices. The results are then integrated into a structured search results page 16. The integration can be facilitated using predefined templates that organize the content by topics into a coherent and user-friendly format. The search results page 16 depicted in FIG. 1 shows a series of topics, labeled from Topic 1 to Topic 7, each representing a distinct category of information relevant to the initial query “Restaurants in LA”. This organization helps the user navigate through the information efficiently, allowing for an intuitive search experience.

In some implementations, the search system 14 may also include model-generated content such as textual justifications or preambles for each topic, which provide additional context or explanations about the results. These textual elements are designed to enhance user understanding and engagement with the content.

Moreover, in some implementations, the search system 14 is capable of dynamically adjusting the topics and the content presented on the search results page 16 based on real-time user interactions. This feature ensures that the displayed information remains relevant and engaging over time, adapting to the user's changing preferences and interactions.

The structure of the search results page 16 as illustrated in FIG. 1 can be strategically designed to enhance user engagement and satisfaction. The page can start with the most general topics at the top, directly answering the user's initial query, and progress to more specific and intriguing topics, culminating in unexpected yet relevant topics at the bottom. This structured progression can assist users with exploring further content that they might not have initially considered.

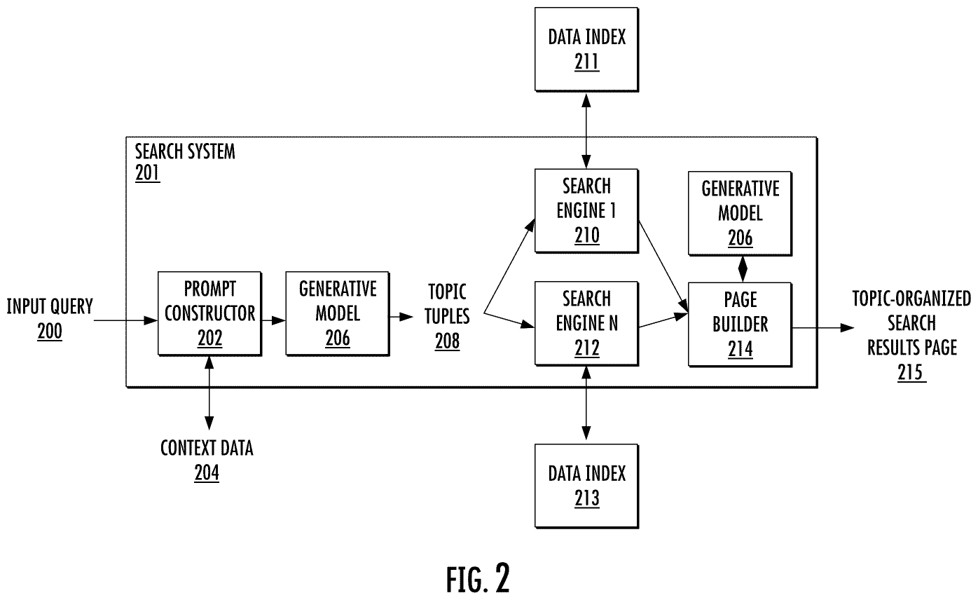

Referring now to FIG. 2, a more detailed block diagram of an example search system 201 is depicted, which illustrates the process flow from receiving an input query 200 to generating a topic-organized search results page 215. This figure provides a comprehensive view of the various components and their interactions within the system, designed to enhance the search experience by leveraging generative models.

The process begins when the search system 201 receives an input query 200 from a user. This query is the initial expression of the user's search intent, which can be input through various means such as text, voice, or other interactive forms. The input query 200 is first processed by the prompt constructor 202, which is responsible for formulating the query in a manner that is optimized for processing by the generative model 206.

The prompt constructor 202 can be refine and structure the user's raw input query before it is fed into a generative model 206. It can incorporate a variety of signal inputs (e.g., context data 204, query structure, and/or system metadata) to construct a context-rich prompt that effectively guides the generative model 206. For instance, the prompt constructor 202 can dynamically merge user preferences, browsing histories, or location-based data with the initial query text to form a single enriched prompt. In doing so, the prompt constructor 202 can also impose standard formatting, enforce data normalization rules, or incorporate system-level parameters such as maximum token counts or model-specific syntax guidelines.

Within the constructed prompt, the prompt constructor 202 can embed explicit instructions that further direct the generative model's behavior. For example, it may specify whether the model should generate structured topic tuples or produce explanatory text in response to each topic. It could also supply sorting requirements, direct the model to exclude certain topics, or include confidence thresholds for deciding when to produce fewer or more expansive results. Thus, the prompt constructor 202 can serve as a pre-processing layer that ensures that the query entering the generative model 206 is fully augmented, contextually guided, and precisely tailored to yield optimal, topic-organized outputs.

As noted, in some implementations, the prompt constructor 202 can also incorporate context data 204, which can include additional information such as user preferences, browsing history, or environmental data like time of day, to enrich the query and tailor the search results more closely to the user's needs.

Specifically, the context data 204 can include user-specific signals such as browsing histories, saved preferences, demographic information, and/or prior search queries. For instance, in a scenario where the user frequently searches for travel-related content, the context data 204 can incorporate historical trips, favored destinations, or even saved budget profiles to guide the generative model 206 toward more relevant topic generation. Additionally, the context data 204 can encompass device-specific details, including device type, operating system version, and screen size, enabling the search system to adapt the structure and layout of the resulting search pages to best suit the user's current environment.

As other examples, the context data 204 can be enriched with environmental and temporal signals that further augment the system's understanding of the user's needs. By way of example, these signals can include the user's geolocation, local weather conditions, real-time traffic data, or even calendar details reflecting upcoming events or deadlines. If the user initiates a query during peak commuting hours, the system can combine time-of-day information with travel preferences stored in the context data 204 to produce topics and results that better fit a hurried schedule. Hence, collectively, these assorted types of contextual information empower the computing system to generate topics more closely aligned with the user's current situational requirements.

The enriched query output by the prompt constructor 202 is then processed by the generative model 206, which in some examples can be an LLM or other large model capable of understanding and generating human-like text. The generative model 206 uses the input from the prompt constructor 202 to dynamically generate topic tuples 208. These topic tuples 208 are structured data elements that include a topic title and one or more specific queries designed to retrieve relevant results from various backend search indices. These indices are represented in FIG. 2 by data index 211 and data index 213, which could include databases containing diverse content types such as web pages, forums, videos, and other digital media. In some implementations, the search system can pull from multiple different backends per topic. For example, the search system can retrieve both web results and place results for a particular topic.

In some implementations, the model 206 is specifically trained to generate topic tuples from user queries. A s one example, the model 206 can be fine-tuned on domain-specific data that highlights various topic branches and corresponding sub-queries relevant to diverse user intents. For example, the model may be trained using curated datasets of broad queries—from travel, food, and shopping to more specialized domains such as health or finance—paired with expert-specified topic decompositions. During fine-tuning, the model can learn to establish logical and intuitive groupings of subtopics, providing coherent and context-aware outputs. This tuple-creation task can be further refined through architectures that incorporate attention mechanisms focusing on user-specific context, such as browsing preferences or past queries, ensuring each topic tuple aligns closely with the user's intent and personal search history.

In some implementations, the generative model 206 can be built to work in conjunction with additional systems such as knowledge graphs or query classifiers, enabling a multi-stage processing pipeline. For instance, preliminary domain or intent classification models can supply contextual signals, which the generative model 206 then leverages to produce more targeted tuples. The system may also employ reinforcement learning or continual learning strategies to refine the generative model 206's output over time, feedback being provided by user interactions with the final topic-organized search results page. Moreover, the model can be configured to operate in real-time, dynamically updating topic tuples as the user's query evolves or as additional signals, like geolocation or temporal factors, are introduced into the search context.

The topic tuples 208 output by the model 206 are then used by multiple search engines, labeled here as Search Engine 1 210 and Search Engine N 212, to retrieve relevant data from the corresponding data indices. Each search engine may specialize in different types of content or operate in different data environments, thereby diversifying the sources from which data is retrieved and enhancing the comprehensiveness of the search results.

The topic tuples 208 drive a more efficient and precise retrieval process by consolidating the requirements for each distinct theme identified by the generative model 206. By bundling together a topic title, the set of particular backend indices, and the specific queries required to search those indices, the system not only reduces latency through targeted retrieval calls but also ensures a higher level of relevance in the final search results. This structure minimizes redundant requests across multiple sources, preserving computational and bandwidth resources. Simultaneously, it enhances the quality of the user experience by distilling the variety of possible search angles into purposeful sets of results that are distinctly organized by context.

Once the relevant data is retrieved from the search enginges, it is sent to the page builder 214. The page builder 214 organizes the retrieved data into a coherent and navigable topic-organized search results page 215. This page can be structured to present the topics in a logical and engaging manner, starting with the most general topics at the top and progressing to more specific and potentially intriguing topics. The page builder 214 may also use the generative model 206 to create additional content, such as textual justifications or preambles for each topic, enhancing the user's understanding and engagement with the search results.

The page builder 214 can combine the results retrieved by the various search engines (e.g., Search Engine 1210, Search Engine N 212) into the final topic-organized search results page 215. In some implementations, the page builder 214 can utilize a system of templates to facilitate consistent and visually coherent displays for users. Specifically, the templates provide a structural blueprint in which output can be populated based on parameters such as text, formatting styles, images, metadata, and layout guidelines. By relying on these templates, the page builder 214 can reliably transform raw search results into a cohesive page design that mirrors both the user's context and the requirements of the generative model 206.

In some implementations, the page builder 214 can store multiple different templates, each tailored to a specific content type (e.g., restaurants, places, videos, or product listings) or a specific user device form factor (e.g., desktop browsers, mobile apps, or embedded displays). When the system obtains the search results from each topic tuple, the page builder 214 processes the metadata accompanying these results, maps them to the correct data fields in a corresponding template, and then merges the content with any additional contextual elements such as user location or user preferences into the rendered output. Additionally, the page builder 214 may leverage dynamic design rules to adjust elements like text size, color scheme, or inclusion of interactive elements (e.g., “scroll for more” carousels) to accommodate different visualization preferences. As a result, it ensures that each topic's section of the search results page adheres to a uniform presentation standard, while still allowing for specialized sections optimized to the nature of the results.

By employing a template-driven page builder 214, the system achieves several notable technical advantages. First, it enforces consistency across the search results presentation, which helps reduce user confusion and streamlines their ability to navigate among topics. Second, because much of the display logic is managed centrally and only requires limited input from the system at run time, the building process can be performed more efficiently. This allows for faster rendering speeds on user devices and reduced overhead in the layout process. Third, updates or enhancements to the presentation layer-such as improved accessibility features or new interactive widgets—can be accomplished by simply modifying the relevant templates, thereby eliminating the need to revamp the entire search results pipeline.

In some implementations, the search system 201 may include features that allow for dynamic adjustments based on real-time user interactions with the search results page 215. These interactions can be tracked and used to refine the search process, adjust the content presentation, and even re-order the topics to better align with the user's evolving interests.

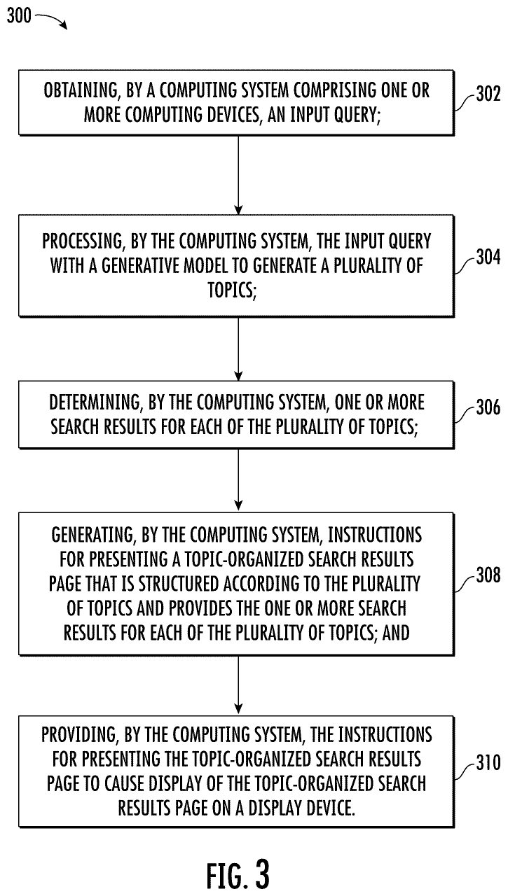

Referring now to FIG. 3, a flowchart diagram illustrates an example method 300 for generating a topic-organized search results page utilizing a computing system equipped with generative models, specifically tailored to enhance user search experiences by dynamically generating search results organized by topic relevance and context. This embodiment is designed to address and streamline the user's search process, particularly when dealing with broad or ambiguously defined queries, by employing advanced language processing techniques.

Block 302 includes an initial step in the method, where the computing system, comprising one or more computing devices, obtains an input query from a user. This input query can be in various forms such as text, voice, or image-based inputs, reflecting the user's current search intent. The flexibility in input methods ensures accessibility and ease of use.

Proceeding to block 304, the computing system processes the input query with a generative model, for example an LLM, to generate a plurality of topics. This process can include the generative model analyzing the query to understand its context and underlying intent, thereby enabling the system to propose a range of topics that are relevant to the query. The generative model can utilize additional contextual information such as the time of day, user location, or previous search history to refine the topics generated, ensuring they are as relevant and personalized as possible.

In block 306, the method continues as the computing system determines one or more search results for each of the generated topics. This determination can include querying various backend search indices, which may include web pages, forums, video content, or other multimedia resources, based on the specific queries associated with each topic tuple generated in the previous step.

Block 308 includes generating instructions for presenting a topic-organized search results page that is structured according to the plurality of topics and provides the search results for each topic. This structuring can be facilitated using predefined templates or dynamically generated layouts that organize the content into an intuitive and user-friendly format. The templates can be designed to enhance readability and engagement, using visual elements such as cards or lists that distinctly separate each topic while maintaining a coherent overall page design.

Finally, block 310 encapsulates the providing of the instructions for presenting the topic-organized search results page to cause the display of this page on a display device. For example, the computing system can communicate with a local renderer or a remote device to cause the search results page to be rendered to the user on their preferred device, be it a mobile phone, tablet, or desktop computer.

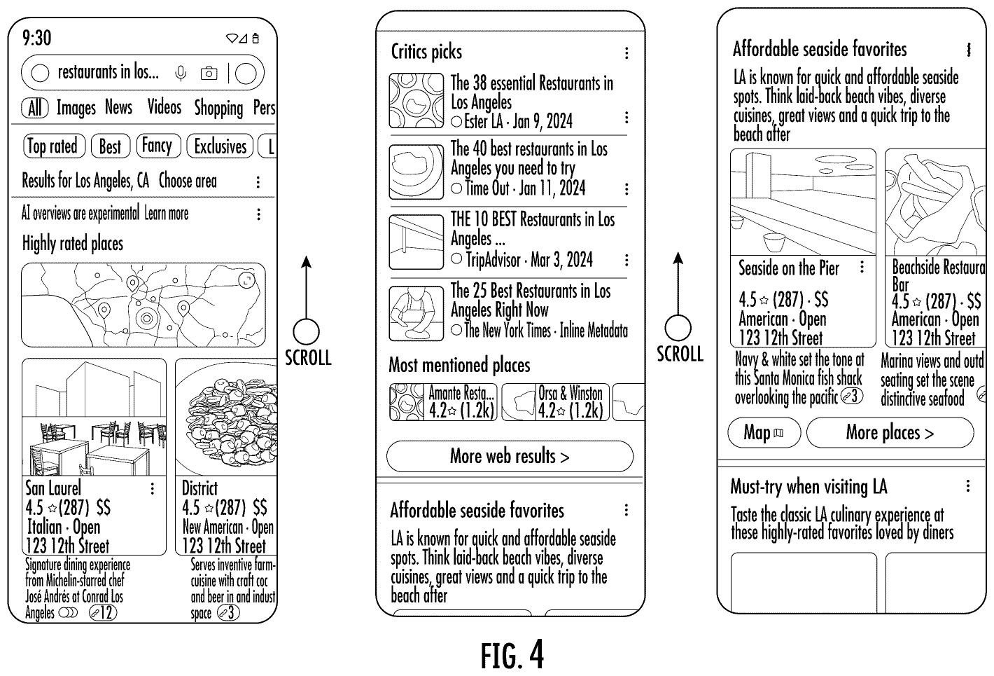

Referring now to FIG. 4, a series of example user interfaces displaying a topic-organized search results page according to example embodiments of the present disclosure is depicted. This figure illustrates the practical application of the search system in providing visually appealing and intuitively navigable search results that are organized by distinct topics, enhancing the user experience by aligning the presentation of information with user intent and preferences.

The first panel on the left illustrates a user interface where the search results for “restaurants in Los Angeles” are organized under the topic “Highly rated places”. This panel shows a combination of a map integration and individual restaurant listings, each with a visual representation, ratings, and brief descriptions. This demonstrates how the search system utilizes backend indices related to geographical data and customer reviews to generate relevant and tailored content for the user. The user can scroll vertically to explore additional topics or categories.

The middle panel includes a topic-specific portion titled “Critics picks”. This portion presents a curated list of restaurant recommendations from various reputable sources. This panel not only lists the names of the restaurants but also provides links to more detailed reviews and articles from these sources. This aspect of the user interface leverages the search system's ability to integrate content from diverse backend indices such as news and review websites, illustrating the system's capacity to aggregate and present expert opinions in a structured manner.

The rightmost panel features the topic “Affordable seaside favorites”, focusing on budget-friendly dining options near the sea in Los Angeles. Each listing can provide a snapshot of the restaurant, user ratings, and/or a small map view, which aids users in making informed decisions based on location and budget preferences. This panel illustrates the system's capability to tailor search results not only by content type but also by specific user preferences such as price range and setting, illustrating the dynamic content personalization enabled by the search system.

In some implementations, some of the panels or cards for a particular topic can be designed to allow horizontal scrolling within the topic, enabling users to explore more options without leaving the context of the selected category. This user interface design minimizes information overload and enhances navigability.

Moreover, in some implementations, the structured layout of the search results page, as depicted across the panels in FIG. 4, is strategically designed to progress from general to more specific topics, thereby guiding the user through a discovery process that is both intuitive and aligned with their initial query. Thus, FIG. 4 illustrates how the search system implements advanced generative models to transform a standard search query into a rich, organized, and engaging search experience.

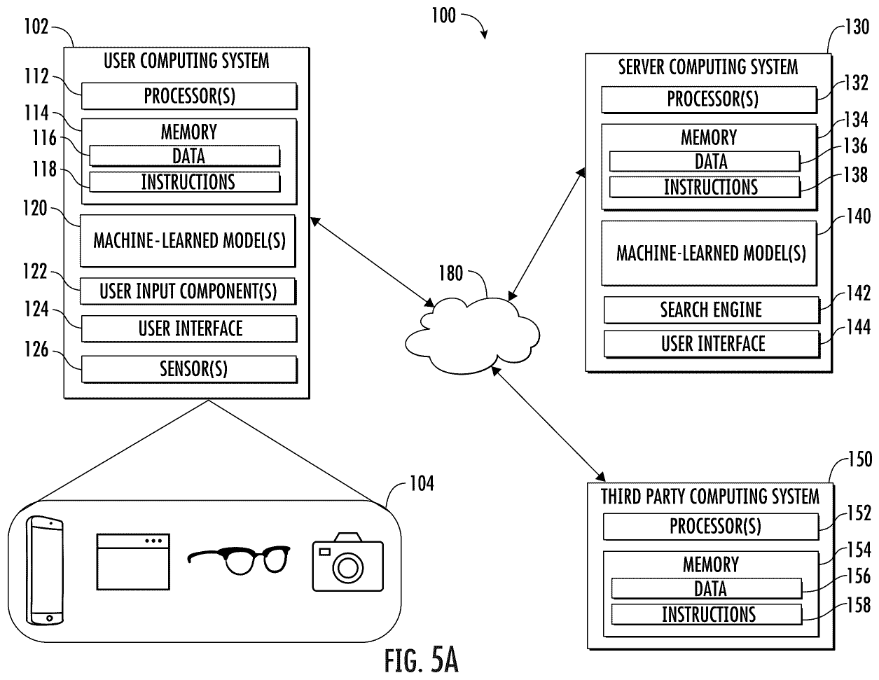

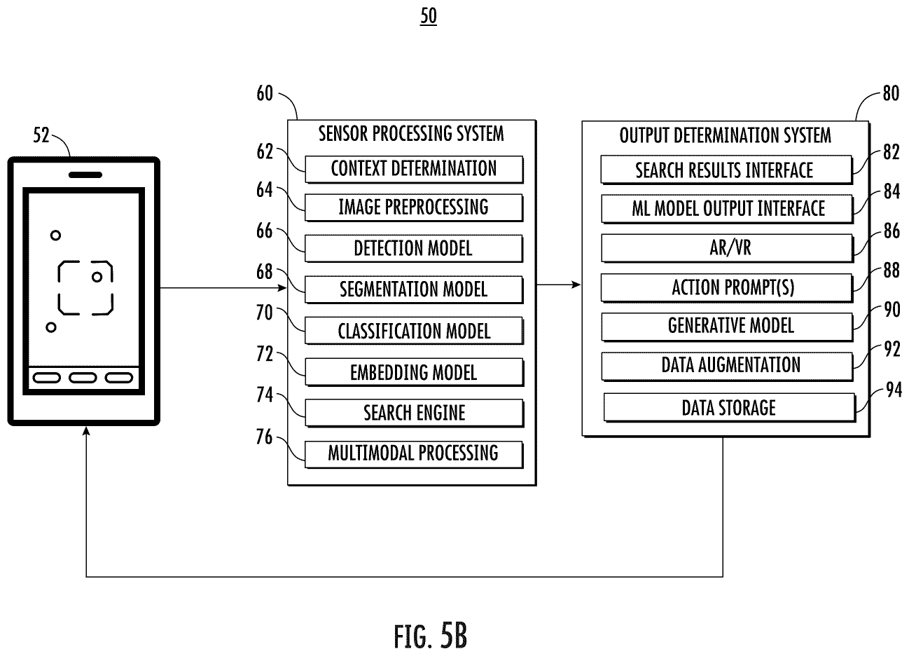

FIG. 5A depicts a block diagram of an example computing system 100 that performs information retrieval according to example embodiments of the present disclosure. The system 100 includes a user computing system 102, a server computing system 130, and/or a third computing system 150 that are communicatively coupled over a network 180.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a viewfinder service, a visual search service, an image processing service, an ambient computing service, and/or an overlay application service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display). The user interfaces 124 may be associated with one or more other computing systems (e.g., server computing system 130 and/or third party computing system 150). The user interfaces 124 can include a viewfinder interface, a search interface, a generative model interface, a social media interface, and/or a media content gallery interface.

The user computing system 102 may include and/or receive data from one or more sensors 126. The one or more sensors 126 may be housed in a housing component that houses the one or more processors 112, the memory 114, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 102 may include, and/or be part of, a user computing device 104. The user computing device 104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 5B.

Additionally and/or alternatively, the server computing system 130 can include and/or be communicatively connected with a search engine 142 that may be utilized to crawl one or more databases (and/or resources). The search engine 142 can process data from the user computing system 102, the server computing system 130, and/or the third party computing system 150 to determine one or more search results associated with the input data. The search engine 142 may perform term based search, label based search, Boolean based searches, image search, embedding based search (e.g., nearest neighbor search), multimodal search, and/or one or more other search techniques.

The server computing system 130 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 102 and/or the server computing system 130 can train the models 120 and/or 140 via interaction with the third party computing system 150 that is communicatively coupled over the network 180. The third party computing system 150 can be separate from the server computing system 130 or can be a portion of the server computing system 130. Alternatively and/or additionally, the third party computing system 150 may be associated with one or more web resources, one or more web platforms, one or more other users, and/or one or more contexts.

The third party computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the third party computing system 150 to perform operations. In some implementations, the third party computing system 150 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SM TP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. A s an example, the machine-learned model(s) can process the natural language data to generate a language encoding output. As another example, the machine-learned model(s) can process the text or natural language data to generate a latent text embedding output. A s another example, the machine-learned model(s) can process the text or natural language data to generate a translation output. A s another example, the machine-learned model(s) can process the text or natural language data to generate a classification output. A s another example, the machine-learned model(s) can process the text or natural language data to generate a textual segmentation output. A s another example, the machine-learned model(s) can process the text or natural language data to generate a semantic intent output. A s another example, the machine-learned model(s) can process the text or natural language data to generate an upscaled text or natural language output (e.g., text or natural language data that is higher quality than the input text or natural language, etc.). A s another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. A s another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). A s another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. A s another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. A s another example, the set of categories can be object classes. A s another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing system 100.

The central intelligence layer can communicate with a central device data layer. The central device data layer can be a centralized repository of data for the computing system 100. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 5B depicts a block diagram of an example computing system 50 that performs information retrieval according to example embodiments of the present disclosure. In particular, the example computing system 50 can include one or more computing devices 52 that can be utilized to obtain, and/or generate, one or more datasets that can be processed by a sensor processing system 60 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 52 (e.g., one or more sensors in the computing device 52). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 52 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 60. The sensor processing system 60 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 62, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 60 may include an image preprocessing block 64. The image preprocessing block 64 may be utilized to adjust one or more values of an obtained and/or received image to prepare the image to be processed by one or more machine-learned models and/or one or more search engines 74. The image preprocessing block 64 may resize the image, adjust saturation values, adjust resolution, strip and/or add metadata, and/or perform one or more other operations.

In some implementations, the sensor processing system 60 can include one or more machine-learned models, which may include a detection model 66, a segmentation model 68, a classification model 70, an embedding model 72, and/or one or more other machine-learned models. For example, the sensor processing system 60 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 68 can be utilized to segment one or more portions of the dataset from the one or more datasets. For example, the one or more segmentation models 68 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 70 can be utilized to process image data, text data, audio data, latent encoding data, multimodal data, and/or other data to generate one or more classifications. The one or more classification models 70 can include one or more image classification models, one or more object classification models, one or more text classification models, one or more audio classification models, and/or one or more other classification models. The one or more classification models 70 can process data to determine one or more classifications.

In some implementations, data may be processed with one or more embedding models 72 to generate one or more embeddings. For example, one or more images can be processed with the one or more embedding models 72 to generate one or more image embeddings in an embedding space. The one or more image embeddings may be associated with one or more image features of the one or more images. In some implementations, the one or more embedding models 72 may be configured to process multimodal data to generate multimodal embeddings. The one or more embeddings can be utilized for classification, search, and/or learning embedding space distributions.

The sensor processing system 60 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 74 may perform feature matching, text based search, embedding based search (e.g., k-nearest neighbor search), metadata based search, multimodal search, web resource search, image search, text search, and/or application search.

Additionally and/or alternatively, the sensor processing system 60 may include one or more multimodal processing blocks 76, which can be utilized to aid in the processing of multimodal data. The one or more multimodal processing blocks 76 may include generating a multimodal query and/or a multimodal embedding to be processed by one or more machine-learned models and/or one or more search engines 74.

The output(s) of the sensor processing system 60 can then be processed with an output determination system 80 to determine one or more outputs to provide to a user. The output determination system 80 may include heuristic based determinations, machine-learned model based determinations, user selection based determinations, and/or context based determinations.

The output determination system 80 may determine how and/or where to provide the one or more search results in a search results interface 82. Additionally and/or alternatively, the output determination system 80 may determine how and/or where to provide the one or more machine-learned model outputs in a machine-learned model output interface 84. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 60 may be utilized to generate and/or provide an augmented-reality experience and/or a virtual-reality experience 86. For example, the one or more obtained datasets may be processed to generate one or more augmented-reality rendering assets and/or one or more virtual-reality rendering assets, which can then be utilized to provide an augmented-reality experience and/or a virtual-reality experience 86 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 88 may be determined based on the output(s) of the sensor processing system 60. For example, a search prompt, a purchase prompt, a generate prompt, a reservation prompt, a call prompt, a redirect prompt, and/or one or more other prompts may be determined to be associated with the output(s) of the sensor processing system 60. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

The output determination system 80 may process the one or more datasets and/or the output(s) of the sensor processing system 60 with a data augmentation block 92 to generate augmented data. For example, one or more images can be processed with the data augmentation block 92 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 60 may be stored based on a data storage block 94 determination.

The output(s) of the output determination system 80 can then be provided to a user via one or more output components of the user computing device 52. For example, one or more user interface elements associated with the one or more outputs can be provided for display via a visual display of the user computing device 52.

The processes may be performed iteratively and/or continuously. One or more user inputs to the provided user interface elements may condition and/or affect successive processing loops.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to provide topic-organized search results, the method comprising:
obtaining, by a computing system comprising one or more computing devices, an input query;
processing, by the computing system, the input query with a generative model to generate a plurality of topics;
determining, by the computing system, one or more search results for each of the plurality of topics;
generating, by the computing system, instructions for presenting a topic-organized search results page that is structured according to the plurality of topics and provides the one or more search results for each of the plurality of topics; and
providing, by the computing system, the instructions for presenting the topic-organized search results page to cause display of the topic-organized search results page on a display device.

2. The computer-implemented method of claim 1, wherein processing, by the computing system, the input query with the generative model to generate the plurality of topics comprises:
supplementing, by the computing system, the input query with one or more sets of context data to generate a context-supplemented input query; and
processing, by the computing system, the context-supplemented input query with the generative model to generate the plurality of topics.

3. The computer-implemented method of claim 2, wherein the one or more sets of context data comprise user preferences or user browsing history associated with a user that submitted the input query.

4. The computer-implemented method of claim 1, wherein processing, by the computing system, the input query with the generative model to generate the plurality of topics comprises processing, by the computing system, the input query with the generative model to generate a plurality of topic tuples as an output of the generative model, wherein each of the plurality of topic tuples comprises one or more topic-specific queries and identifies one or more particular search index types or data sources to query using the one or more one or more topic-specific queries.

5. The computer-implemented method of claim 4, wherein determining, by the computing system, the one or more search results for each of the plurality of topics comprises, for each topic tuple, querying, by the computing system, the one or more particular search index types or data sources identified by the topic tuple with the one or more topic-specific queries to retrieve the one or more search results for the topic associated with the topic tuple.

6. The computer-implemented method of claim 1, wherein generating, by the computing system, the instructions for presenting the topic-organized search results page comprises, for at least one of the one or more search results, applying, by the computing system, a template to metadata associated with the search result to generate a result representation for inclusion in the topic-organized search results page.

7. The computer-implemented method of claim 1, wherein generating, by the computing system, the instructions for presenting the topic-organized search results page comprises, for at least one of the topics, processing, by the computing system, data associated with the topic with a second generative model to generate a textual justification or preamble for the topic, wherein the textual justification or preamble is included in the topic-organized search results page.

8. The computer-implemented method of claim 1, wherein the topic-organized search results page presents the plurality of topics ordered from general to specific.

9. The computer-implemented method of claim 1, wherein the topic-organized search results page presents the plurality of topics respectively in a plurality of visual cards, wherein the plurality of visual cards are arranged vertically, and wherein the one or more search results for each topic are arranged horizontally within the visual card associated with that topic.

10. The computer-implemented method of claim 1, further comprising:
processing, by the computing system, the input query with an intent classification model to generate one or more intent labels that describes an intent of the input query;
wherein processing, by the computing system, the input query with the generative model to generate the plurality of topics comprise processing, by the computing system, the input query and the one or more intent labels with the generative model to generate the plurality of topics.

11. The computer-implemented method of claim 1, wherein the generative model comprises a sequence processing model, the sequence processing model comprising a language model or a multi-modal model.

12. A computing system, comprising:
one or more processors; and
one or more non-transitory computer-readable media that store instructions that, when executed by the one or more processors, cause the computing system to perform operations, the operations comprising:
obtaining, by the computing system, an input query;
processing, by the computing system, the input query with a generative model to generate a plurality of topics;
determining, by the computing system, one or more search results for each of the plurality of topics;
generating, by the computing system, instructions for presenting a topic-organized search results page that is structured according to the plurality of topics and provides the one or more search results for each of the plurality of topics; and
providing, by the computing system, the instructions for presenting the topic-organized search results page to cause display of the topic-organized search results page on a display device.

13. The computing system of claim 12, wherein processing, by the computing system, the input query with the generative model to generate the plurality of topics comprises:
supplementing, by the computing system, the input query with one or more sets of context data to generate a context-supplemented input query; and
processing, by the computing system, the context-supplemented input query with the generative model to generate the plurality of topics.

14. The computing system of claim 13, wherein the one or more sets of context data comprise user preferences or user browsing history associated with a user that submitted the input query.

15. The computing system of claim 12, wherein processing, by the computing system, the input query with the generative model to generate the plurality of topics comprises processing, by the computing system, the input query with the generative model to generate a plurality of topic tuples as an output of the generative model, wherein each of the plurality of topic tuples comprises one or more topic-specific queries and identifies one or more particular search index types or data sources to query using the one or more one or more topic-specific queries.

16. The computing system of claim 15, wherein determining, by the computing system, the one or more search results for each of the plurality of topics comprises, for each topic tuple, querying, by the computing system, the one or more particular search index types or data sources identified by the topic tuple with the one or more topic-specific queries to retrieve the one or more search results for the topic associated with the topic tuple.

17. The computing system of claim 12, wherein generating, by the computing system, the instructions for presenting the topic-organized search results page comprises, for at least one of the one or more search results, applying, by the computing system, a template to metadata associated with the search result to generate a result representation for inclusion in the topic-organized search results page.

18. The computing system of claim 12, wherein generating, by the computing system, the instructions for presenting the topic-organized search results page comprises, for at least one of the topics, processing, by the computing system, data associated with the topic with a second generative model to generate a textual justification or preamble for the topic, wherein the textual justification or preamble is included in the topic-organized search results page.

19. The computing system of claim 12, wherein the operations further comprise:
processing, by the computing system, the input query with an intent classification model to generate one or more intent labels that describes an intent of the input query;
wherein processing, by the computing system, the input query with the generative model to generate the plurality of topics comprise processing, by the computing system, the input query and the one or more intent labels with the generative model to generate the plurality of topics.

20. One or more non-transitory computer-readable media that store instructions that, when executed by one or more processors of a computing system, cause the computing system to perform operations, the operations comprising:
obtaining, by the computing system, an input query;
processing, by the computing system, the input query with a generative model to generate a plurality of topics;
determining, by the computing system, one or more search results for each of the plurality of topics;
generating, by the computing system, instructions for presenting a topic-organized search results page that is structured according to the plurality of topics and provides the one or more search results for each of the plurality of topics; and
providing, by the computing system, the instructions for presenting the topic-organized search results page to cause display of the topic-organized search results page on a display device.
